(19) United States
(12) Patent Application Publication
(10) Pub. No.: US 2009/0235206 A1
(43) Pub. Date: Sep. 17, 2009

(54) PORTABLE DEVICE OPERATING METHOD

(76) Inventor: Shih-Chan Hsu, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/395,714

(22) Filed: Mar. 2, 2009

(30) Foreign Application Priority Data
Mar. 14, 2008 (TW) 097109020

(51) Int. Cl. G06F 3/048

(52) U.S. Cl. 715/836

(57) ABSTRACT

The present invention provides a portable device operating method including: displaying a three-dimensional function menu on a display screen of a portable device, wherein a plurality of items of the three-dimensional function menu are positioned on different directions in a three-dimensional coordinate; detecting a shaking direction of the portable device; and selecting one of the plurality of the items of the three-dimensional function menu according to the shaking direction.

### BACKGROUND OF THE INVENTION

1. Field of the Invention

The present invention relates to a portable device operating method, and more particularly, to an operating method capable of shaking a portable device by different shaking directions to browse a three-dimensional function menu of the portable device and operate functions.

2. Description of the Prior Art

Please refer to FIG. 1. FIG. 1 shows a simplified diagram of a conventional cellphone 10 appearance and a function menu 200 thereof. As shown in FIG. 1, the cellphone 10 comprises a display screen 12, a first function key 110, a second function key 120, and a direction key 130. In general, the operating method of the cellphone 10 is using the direction key 130 to browse the function menu 200 in the display screen 12 of the cellphone 10. When browsing an item of the function menu 200, the first function key 110 is utilized for selecting the item and executing the function of the selected item. After the function of the selected item is executed, the second function key 120 is utilized for stopping executing the function of the selected item.

Please refer to FIG. 2. FIG. 2 shows a simplified diagram of a structure of the function menu 200. As shown in FIG. 2, the structure of the function menu 200 is a tree structure. There are nine items in the first layer list 210 of the function menu 200: the internet 211, the phonebook 212, the call history 213, the message 214, the organizer 215, the camera 216, the media player 217, the games 218, and the settings 219, wherein each item has its own sub tree structure. For example, there are eight items in the second layer list 220 after entering the settings 219: the phone settings 221, the display settings 222, the ringtone settings 223, the profiles settings 224, the call settings 225, the connect settings 226, the network settings 227, and the security settings 228. There are also eight items in the third layer list 230 after entering the call settings 225: the answer mode 231, the minute minder 232, the caller identity 233, the call divert 234, the call waiting 235, the auto redial 236, the fixed dialing No. 237, the user group 238. In general, the items in the same sub tree structure are related with each other, but when the related items are in the different sub tree structures, it is not convenient for the user to move from one item to another related item. For example, the phone settings 221 in the second layer list 220 in FIG. 2 and the phonebook 212 in the first layer list 210 are related items. When the user moves to the phone settings 221 in the second layer list 220, the user may want to use the phonebook 212. At this time, the user has to press the second function key 120 in FIG. 1 to exit from the second layer list 220 to the first layer list 210 at first, and then use the direction key 130 in FIG. 1 to move to the phonebook 212 by moving upward, downward, leftward, or rightward, and then press the first function key 110 in FIG. 1 to enter the phonebook 212. This conventional operating method is very complex due to the tree structure, and the conventional operating method is not easy to use for the user and wastes the user's time.

### SUMMARY OF THE INVENTION

It is therefore one of the objectives of the present invention to provide a portable device operating method. The operating method can browse a three-dimensional function menu of the portable device and operate functions of the portable device according to different shaking directions of the portable device, so as to solve the above problem.

According to an embodiment of the present invention, a portable device operating method is disclosed. The operating method comprises: displaying a three-dimensional function menu on a display of a portable device, wherein a plurality of items of the three-dimensional function menu are positioned on different directions in a three-dimensional coordinate; detecting a shaking direction of the portable device; and selecting one of the plurality of the items according to the shaking direction.

According to an embodiment of the present invention, a portable device operating method is disclosed. The operating method comprises: receiving a shaking signal generated by a shaking sensor of a portable device; identifying a shaking direction according to the shaking signal; and selecting an item of a function menu according to the shaking direction, wherein the function menu is a three-dimensional function menu, and a plurality of items of the three-dimensional function menu are positioned on different directions in a three-dimensional coordinate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified diagram of a conventional cellphone appearance and a function menu thereof.

FIG. 2 shows a simplified diagram of a structure of the function menu.

FIG. 3 shows a simplified diagram of a cellphone appearance according to an embodiment of the present invention.

FIG. 4 shows a three-dimensional function menu on a display screen of the cellphone.

FIG. 5 shows a three-dimensional function menu on a display screen of the cellphone.

FIG. 6 shows a three-dimensional function menu on a display screen of the cellphone.

FIG. 7 shows a simplified diagram of a net structure of the three-dimensional function menu.

FIG. 8 shows a three-dimensional function menu on a display screen of the cellphone.

### DETAILED DESCRIPTION

The present invention relates to a portable device operating method. The operating method can shake a portable device by different shaking directions to browse a three-dimensional function menu of the portable device and operate functions of the portable device, and this document will describe several exemplary embodiments that apply the operating method of the present invention. However, a person of ordinary skill in the art should understand that the present invention can be applied for various types of portable device and is not limited to the particular embodiments described in the following paragraphs or to the particular manner in which any features of such embodiments are implemented.

In general, the operating method of the present invention can be applied to all kinds of portable device. An operating method applied to a cellphone comprising a 3-axis accelerometer sensor is disclosed in this document, wherein the 3-axis accelerometer sensor is utilized as a shaking sensor. However, this is only for illustration purposes and is not meant to be a limitation of the present invention. In addition, the cellphone will be used in this document as an example to illustrate the operation principles of the method according to the present invention.

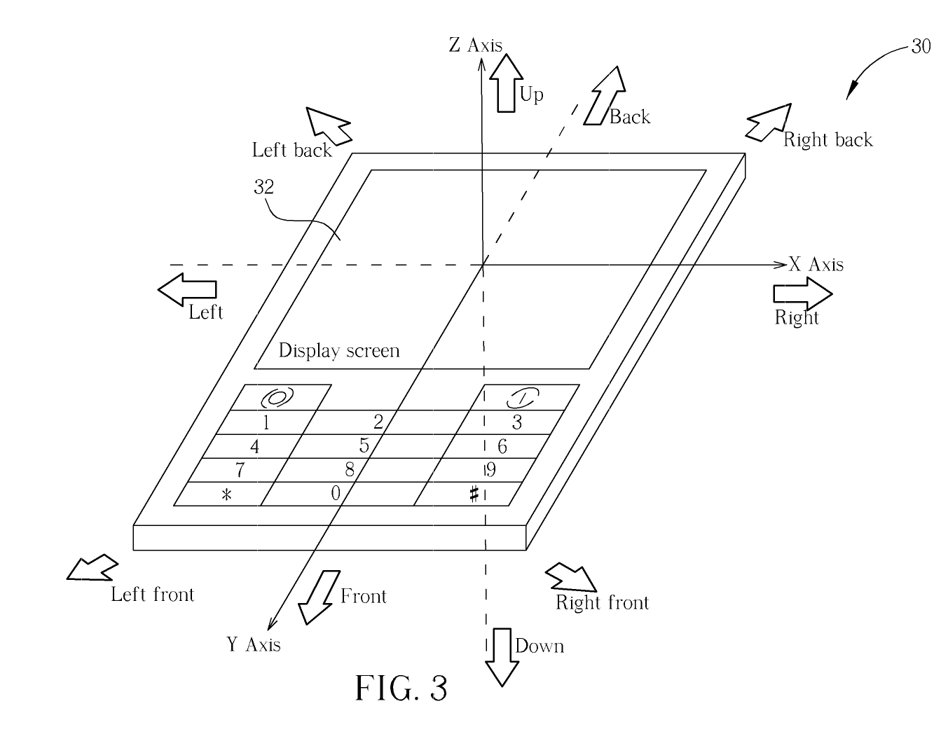

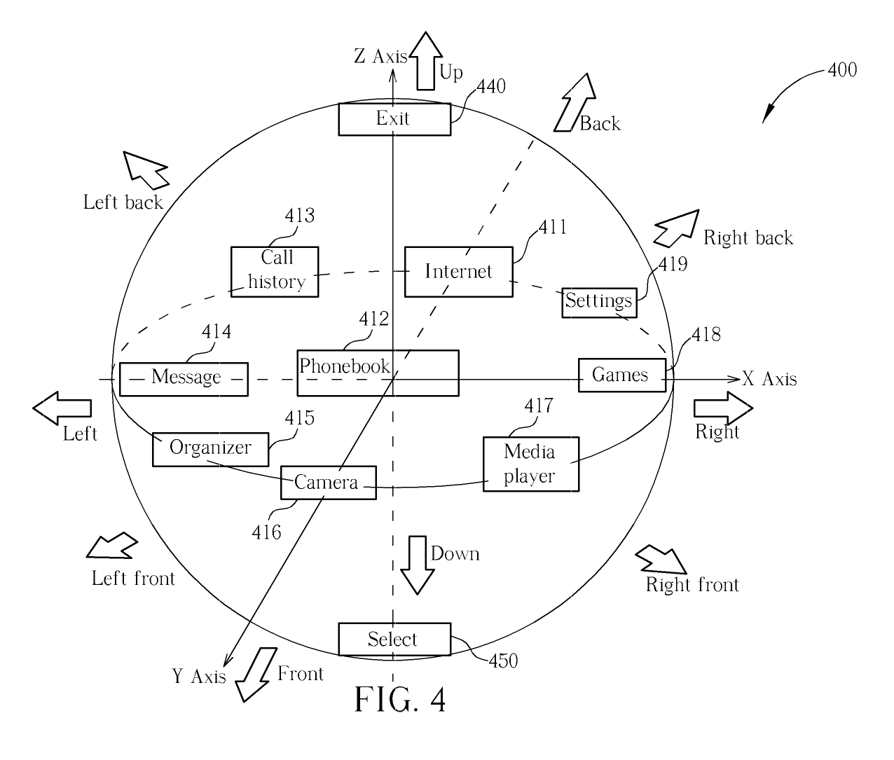

Please refer to FIG. 3 and FIG. 4. FIG. 3 shows a simplified diagram of the appearance of a cellphone 30 according to an embodiment of the present invention. The cellphone 30 comprises a 3-axis accelerometer sensor (not shown). FIG. 4 shows a three-dimensional function menu 400 on a display screen 32 of the cellphone 30. As shown in FIG. 4, after a user start function menu of the cellphone 30, the operating method of the present invention firstly displays the three-dimensional function menu 400 on the display screen 32 of the cellphone 30. The three-dimensional function menu 400 has a plurality of items which are positioned on different directions in a three-dimensional coordinate.

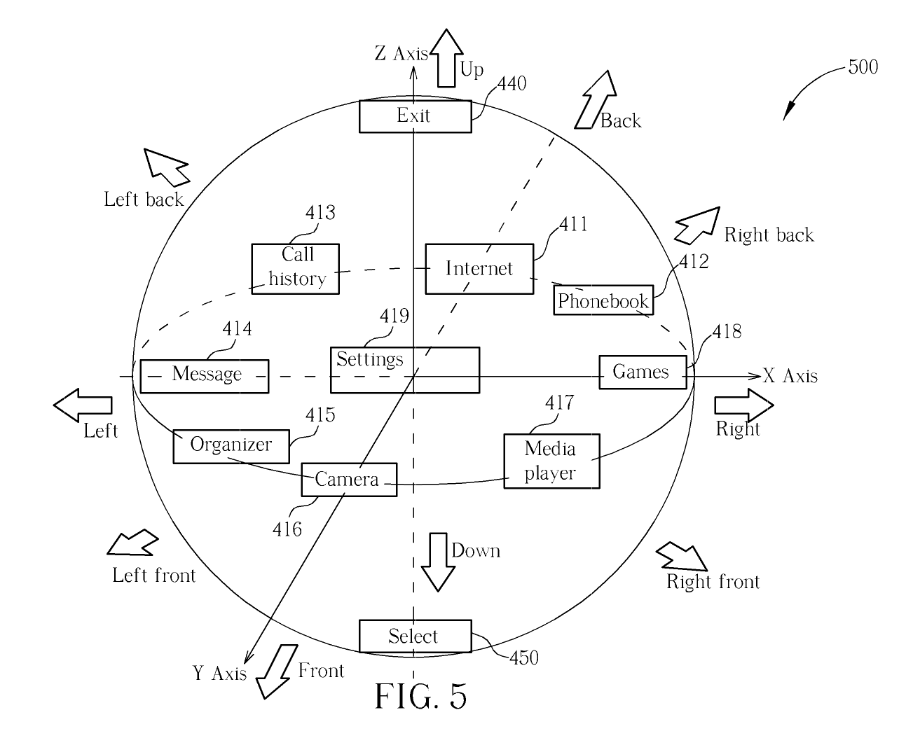

In this embodiment, the item in the center position of the three-dimensional function menu 400 is defined as a current item such as the phonebook 412 shown in FIG. 4. A back position, a left back position, a left position, a left front position, a front position, a right front position, a right position, a right back position, a up position, and a down position of the three-dimensional function menu 400 are respectively defined as the internet 411, the call history 413, the message 414, the organizer 415, the camera 416, the media player 417, the games 418, the settings 419, the exit 440 (i.e. quit a current list of the three-dimensional function menu 400), and the select 450 (i.e. select to enter/execute a current item in the center position of the three-dimensional function menu 400). In this way, the operating method of the present invention use the 3-axis accelerometer sensor of the cellphone 30 to detect a shaking direction of the cellphone 30, and then select an item at the shaking direction of the three-dimensional function menu 400. For example, when the user activates a shaking control function of the cellphone 30, the 3-axis accelerometer sensor of the cellphone 30 will start to detect a shaking direction of the cellphone 30 to generate a shaking signal. For example, when the user shakes the cellphone 30 right backward once, the 3-axis accelerometer sensor of the cellphone 30 will generate a right backward shaking signal. Next, the cellphone 30 can identify a shaking direction according to the shaking signal, and finally select an item corresponding to the shaking direction of the three-dimensional function menu 400. In this embodiment, the user shakes the cellphone 30 right backward, and thus the item of “settings 419” in the right back position of the three-dimensional function menu 400 will be selected. That is, the item of “settings 419” is moved to the center position of the three-dimensional function menu 400 as shown in FIG. 5. At this time, if the user shakes the cellphone 30 downward, this action will let the three-dimensional function menu 400 enters the item of “settings 419”.

An embodiment of the present invention can further detecting a specific shaking condition of the cellphone 30 to determine whether entering or executing the item directly. For example, as shown in the three-dimensional function menu 400 in FIG. 4, when the user shakes the cellphone 30 right backward two time continuously, the cellphone 30 will enter the item of “settings 419” directly.

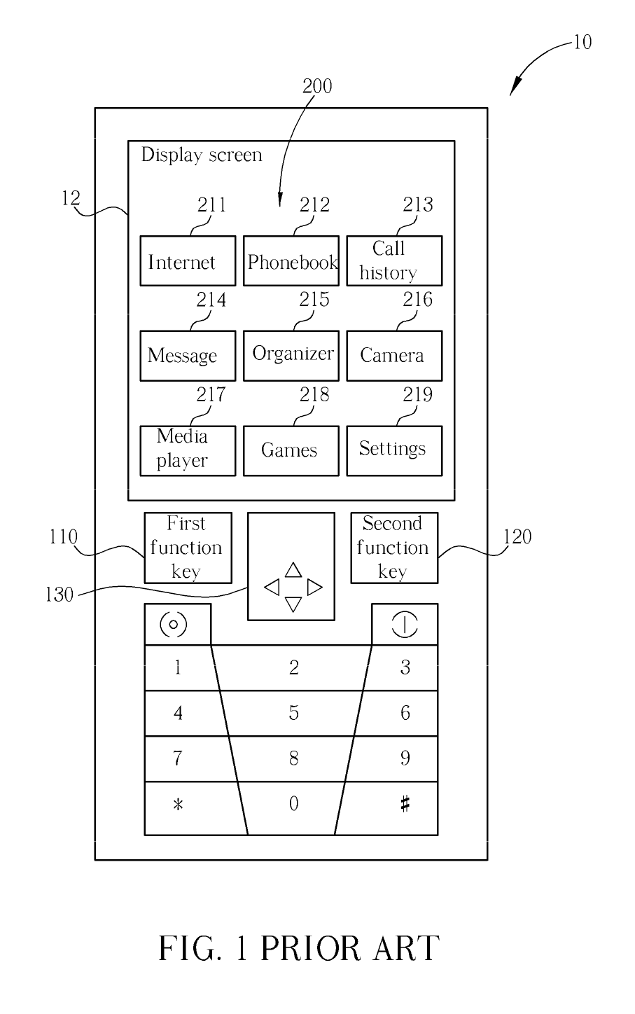

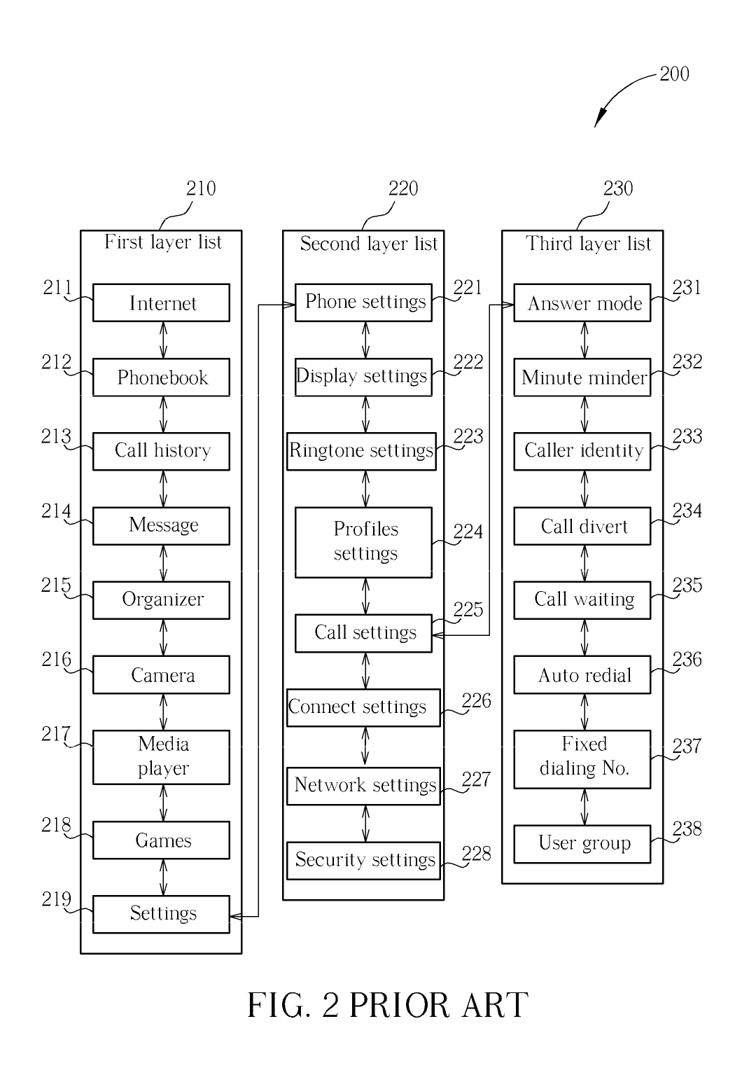

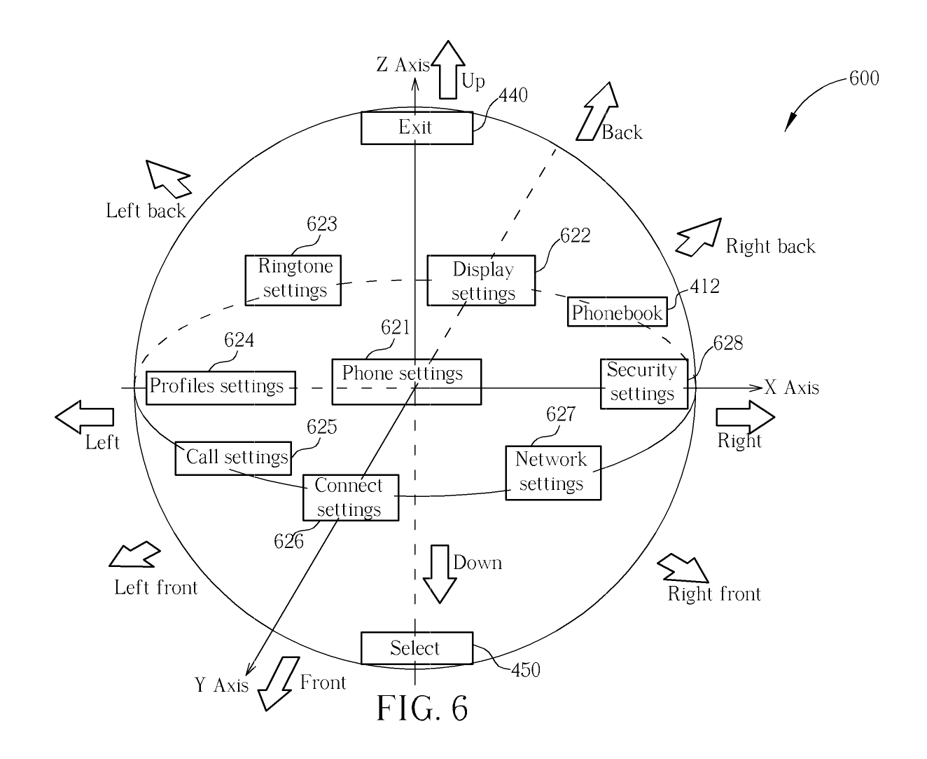

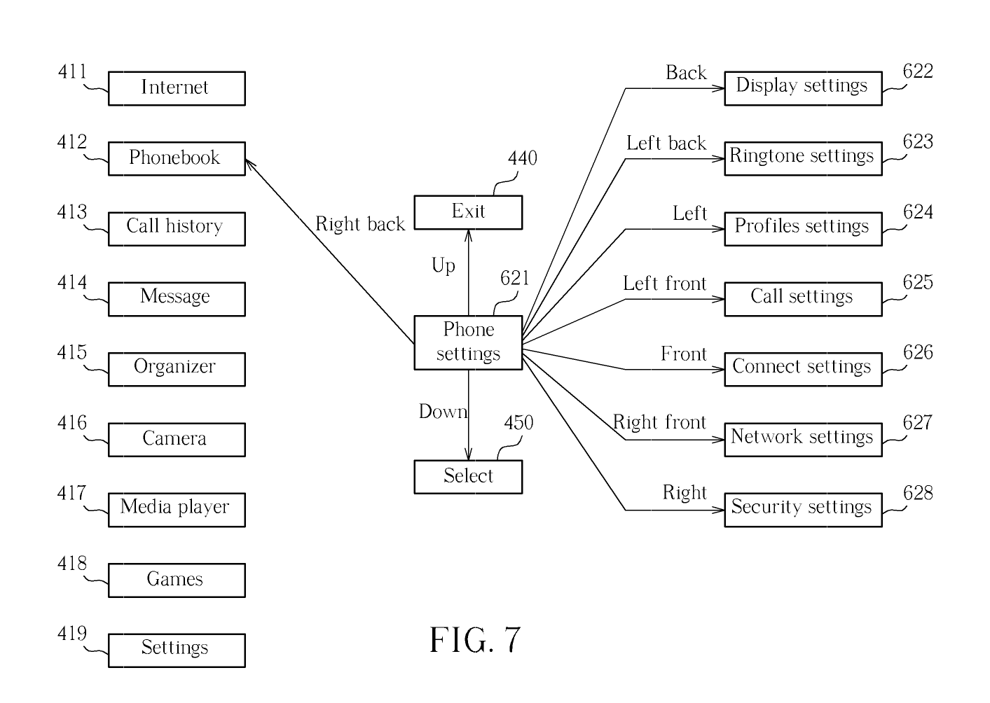

In this embodiment, the items of the three-dimensional function menu 400 of the cellphone 30 connect to each other to form a net structure. Please refer to FIG. 6 and FIG. 7. FIG. 6 shows a three-dimensional function menu 600 of the cellphone 30 under the item of “settings 419”. FIG. 7 shows a part of the net structure of the three-dimensional function menu of the cellphone 30. As shown in FIG. 6, the operating method can move from the phone settings 621 to the other related items or the items that the user frequently uses, for example, the display settings 622, the ringtone settings 623, the profiles settings 624, the call settings 625, the connect settings 626, the network settings 627, the security settings 628, and the phonebook 412, in multi-direction by utilizing the net structure of the three-dimensional function menu. In this embodiment, the phonebook 412 is the item that the user frequently uses, and thus disposing the phonebook 412 in the list shown in FIG. 6 can let user move to the phonebook 412 fast when selecting the phone settings or finishing the phone settings. In this way, the problems caused by the tree structure in the conventional cellphone operating method can be solved. For example, in the conventional cellphone shown in FIG. 1 and FIG. 2, when a user wants to move from the phone settings 221 to the phonebook 212 in the function menu of the conventional cellphone, he or she requires a complex and long operating process because the phone settings 221 to the phonebook 212 are respectively disposed in the second layer list 220 and the first layer list 210 in the conventional tree structure in FIG. 2, and only the phone settings 221 and the settings 219 can connect to each other between the second layer list 220 and the first layer list 210. In comparison with the conventional tree structure, the net structure in the present invention can let the phone settings 621 directly connect to the related items such as the display settings 622, the ringtone settings 623, profiles settings 624, the call settings 625, the connect settings 626, the network settings 627, the security settings 628, and the phonebook 412, and thus the present invention operating method can move directly from the phone settings 621 to the phonebook 412 via the net structure.

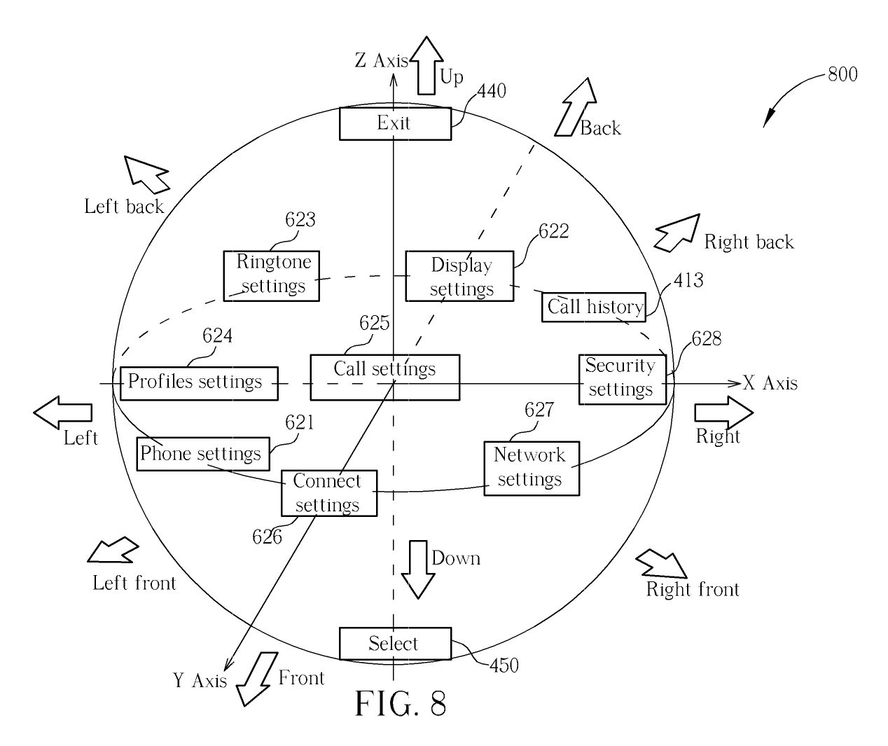

Similarly, the other items in the three-dimensional function menu 600 of the present invention also can move to the other related items in multi-direction like the phone settings 621. In addition, it is also practical to let the user define the connection between each item in the three-dimensional function menu 600. For example, the user can shake the cellphone 30 left forward to select the call settings 625, and the function menu displayed in the screen of the cellphone 30 will become the three-dimensional function menu 800 in FIG. 8 from the three-dimensional function menu 600 in FIG. 6. As shown in FIG. 8, the call settings 625 also can move to the other related items in multi-direction. Please note that the item in the right back position of the three-dimensional function menu 800 is the call history 413, which is different from the phonebook 412 in the right back position of the three-dimensional function menu 600. When the user handle the call settings, the user may want to refer to previous call records, and thus the three-dimensional function menu 800 can let the user directly connect to the call history 413 from the call settings 625.

In addition, please note that the above embodiment is only for an illustrative purpose and is not meant to be a limitation of the present invention. The setting of connection relations among the items in the three-dimensional function menu can be a customized setting, and it is also practical to let the user set the setting. For example, please refer to FIG. 6 again. The user can define more different items in the different positions of the three-dimensional function menu 600 (such as right up position, left up position, right down position, and left down position). That is, the phone settings 621 in FIG. 6 can directly connect to more different items (For example, the user can define that shaking the cellphone 30 right up will move to the internet 411).

A person of ordinary skill in the art should be able to easily understand that the cellphone applying the present invention operating method can let the user be able to easily browse a function menu of the cellphone and operate functions of the cellphone. In comparison with a cellphone applying the conventional operating method, the cellphone applying the present invention operating method can let the user move from one item to another related item faster to save the user's precious time.

Those skilled in the art will readily observe that numerous modifications and alterations of the device and method may be made while retaining the teachings of the invention.

What is claimed is:

1. A portable device operating method, comprising steps of:
displaying a three-dimensional function menu on a display of a portable device, wherein a plurality of items of the three-dimensional function menu are positioned on different directions in a three-dimensional coordinate;
detecting a shaking direction of the portable device; and
selecting one of the plurality of the items of the three-dimensional function menu according to the shaking direction.

2. The operating method of claim 1, wherein in the step of selecting one of the plurality of the items of the three-dimensional function menu according to the shaking direction, the selected item is at the shaking direction of the three-dimensional function menu.

3. The operating method of claim 1, wherein the plurality of the items of the three-dimensional function menu are displayed in different screens of the display, and the plurality of the items connect to each other to form a net structure.

4. The operating method of claim 3, wherein connection relations among the plurality of the items are capable of being set by users.

5. The operating method of claim 1, further comprising step of:
activating a shaking function of the portable device.

6. The operating method of claim 1, after the step of selecting one of the plurality of the items of the three-dimensional function menu according to the shaking direction, the operating method further comprising step of:
detecting a specific shaking condition of the portable device to determine whether executing the selected item.

7. The operating method of claim 6, wherein when the portable device shaking at the shaking direction for specific times is detected, the selected item is executed.

8. The operating method of claim 1, wherein the portable device utilizes a shaking sensor to detecting the shaking direction.

9. A portable device operating method, comprising steps of:
receiving a shaking signal generated by a shaking sensor of a portable device;
identifying a shaking direction according to the shaking signal; and
selecting an item of a function menu according to the shaking direction, wherein the function menu is a three-dimensional function menu, and a plurality of items of the three-dimensional function menu are positioned on different directions in a three-dimensional coordinate.

10. The operating method of claim 9, further comprising step of:
displaying the function menu on a display of the portable device.

11. The operating method of claim 9, wherein the plurality of the items of the three-dimensional function menu are displayed in different screens of the portable device, and the plurality of the items connect to each other to form a net structure.

12. The operating method of claim 9, wherein in the step of selecting an item of a function menu according to the shaking direction, the item is at the shaking direction of the three-dimensional function menu.

13. The operating method of claim 9, further comprising step of:
activating the shaking sensor of the portable device.

14. The operating method of claim 9, after the step of selecting an item of a function menu according to the shaking direction, the operating method further comprising step of:
detecting a specific shaking condition of the portable device to determine whether executing the selected item.
